(19) United States
(12) Patent Application Publication
(10) Pub. No.: US 2024/0419112 A1
(43) Pub. Date: Dec. 19, 2024

(54) IMAGE FORMING DEVICE

(71) Applicant: TOSHIBA TEC KABUSHIKI KAISHA, Tokyo (JP)

(72) Inventor: Suguru Kurita, Sunto Shizuoka (JP)

(21) Appl. No.: 18/333,580

(22) Filed: Jun. 13, 2023

(51) Int. Cl. G03G 15/00; G03G 15/16

(52) U.S. Cl. CPC G03G 15/5058; G03G 15/1605; G03G 15/55

(57) ABSTRACT

An image forming device includes a transfer belt, a plurality of image forming units, a plurality of sensors, and a processor. The plurality of image forming units are arranged in a moving direction of the transfer belt, and form the toner images on the transfer belt. The plurality of sensors detect the toner images formed on the transfer belt. The processor determines a relative positional misalignment among the toner images formed by the plurality of image forming units based on detection results output from the plurality of sensors, and performs alignment control of adjusting formation timings of the toner images on the transfer belt in the plurality of image forming units based on a determination result. The processor further performs abnormality determination processing based on a difference value among the detection results output from the plurality of sensors, and outputs a determination result of the abnormality determination processing.

### FIELD

Embodiments described herein relate generally to an image forming device, and image forming method, and an image forming apparatus.

### BACKGROUND

An image forming device placed on a work place forms an image on a sheet. A general image forming device forms a latent image on a photosensitive drum by irradiating the photosensitive drum with image light from an exposure device. The image forming device visualizes the latent image using a visualization material (developer) to obtain a visible image. The image forming device temporarily moves the visible image to a transfer belt, and further moves the visible image moved to the transfer belt onto a sheet. The image forming device causes a fixing device to fix, on the sheet, the visible image moved onto the sheet.

In such an image forming device, by performing alignment control, it is possible to adjust a timing of forming the latent image on the photosensitive drum so that the image is transferred to an appropriate position of the transfer belt. In the alignment control, a toner image formed on the photosensitive drum or the transfer belt is detected by an optical sensor, a positional misalignment of the toner image is determined based on a detection timing of the toner image, and a formation position of the latent image is corrected.

Optical sensor contamination or belt abrasion occurs depending on a use environment and life of a consumable product. If optical sensor contamination or belt abrasion occurs, a detection value of the toner image detected by the optical sensor varies, and as a result, an accurate position correction cannot be performed.

### DESCRIPTION OF THE DRAWINGS

FIG. 1 is a schematic configuration diagram illustrating an intercommunication system including image forming devices and a server according to first to third embodiments;

FIG. 2 is a schematic cross-sectional view illustrating an example of the image forming device;

FIG. 3 is a schematic configuration diagram illustrating an example of a sensor unit;

FIG. 4 is a block diagram illustrating an example of a circuit configuration of the image forming device;

FIG. 5 is a block diagram illustrating a configuration example of a processor;

FIG. 6 is a flowchart illustrating an example of an overall operation;

FIG. 7 is a diagram illustrating an example of waveforms of sensor detection values and sensor output values of binarization sensors;

FIG. 8 is a diagram illustrating a relationship between magnitudes of the sensor detection values and pattern line widths appearing as the sensor output values;

FIG. 9 is a diagram illustrating an example of a relationship between the pattern line widths and the sensor detection values;

FIG. 10 is a flowchart illustrating an example of an abnormality detection processing operation;

FIG. 11 is a block diagram illustrating an example of a circuit configuration of an image forming device according to a second embodiment;

FIG. 12 is a flowchart illustrating an example of an abnormality detection processing operation; and

FIG. 13 is a flowchart illustrating an example of an overall operation of an image forming device according to a third embodiment.

### DETAILED DESCRIPTION

An image forming device according to an embodiment includes a transfer belt, a plurality of image forming units, a plurality of sensors, and a processor. Toner images are formed on the transfer belt. The plurality of image forming units are arranged in a moving direction of the transfer belt, and form the toner images on the transfer belt. The plurality of sensors detect the toner images formed on the transfer belt. The processor determines a relative positional misalignment between the toner images formed by the plurality of image forming units based on detection results output from the plurality of sensors, and performs alignment control of adjusting formation timings of the toner images on the transfer belt in the plurality of image forming units based on a determination result. The processor is further configured to perform abnormality determination processing based on a difference value among the detection results output from the plurality of sensors, and output a determination result of the abnormality determination processing.

Hereinafter, an image forming device according to an embodiment will be described with reference to the drawings. In the drawings used for describing the following embodiments, a scale of a portion is changed as appropriate. In the drawings used for describing the following embodiments, a configuration is omitted as appropriate for the sake of description.

### First Embodiment

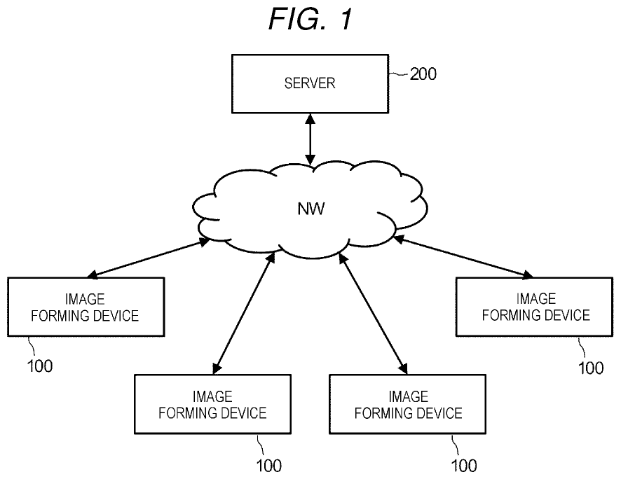

FIG. 1 is a schematic configuration diagram illustrating an intercommunication system including image forming devices and a server according to a first embodiment. The intercommunication system includes a plurality of image forming devices 100 and a server 200. The image forming device 100 may be communicably connected to other image forming devices 100 and the server 200 via a network NW. Although four image forming devices 100 are illustrated in FIG. 1, the present disclosure is not limited thereto. For example, the server 200 may be operated by a service company that performs maintenance and inspection of the image forming device 100. In this case, the network NW may be a public network such as the Internet. The server 200 may be an in-house server operated by a management department in a company. In this case, the network NW may be an in-house local area network (LAN).

Although not particularly illustrated, the image forming device 100 is connected to a user terminal such as a personal computer in a wired or wireless manner.

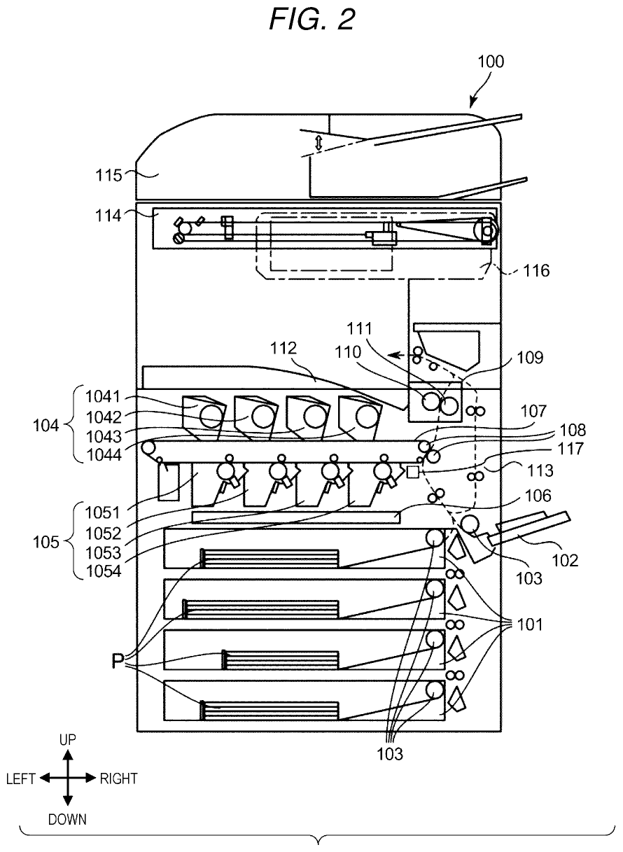

FIG. 2 is a schematic cross-sectional view illustrating an example of the image forming device 100 according to the first embodiment. In FIG. 2, a front direction of the paper is a front direction of the image forming device 100, and a depth direction of the paper is a back direction of the image forming device 100. Upward, downward, left, and right directions of the image forming device 100 are as illustrated in FIG. 2. Hereinafter, the image forming device 100 will be described with reference to FIG. 2.

The image forming device 100 performs printing using an electrophotographic method. The image forming device 100 is, for example, a multifunction peripheral (MFP), a copier, a printer, or a facsimile. As illustrated in FIG. 2, the image forming device 100 includes, for example, sheet feeding trays 101, a manual feeding tray 102, sheet feeding rollers 103, a toner cartridge 104, an image forming unit 105, an optical scanning device 106, a transfer belt 107, transfer rollers 108, a fixing unit 109, a heating unit 110, a pressure roller 111, a sheet discharge tray 112, a duplex unit 113, a scanning unit 114, a document feeding device 115, a control panel 116, and a sensor unit 117.

The image forming unit 105 prints an image using an electrophotographic method. That is, the image forming unit 105 forms an image on an image forming medium P or the like using toner. The image forming medium P is, for example, a sheet-shaped paper. The scanning unit 114 reads an image from a document or the like in which an image is formed. For example, the image forming device 100 implements document copying by printing an image that is read from a document or the like using the scanning unit 114 on the image forming medium P using the image forming unit 105.

The sheet feeding tray 101 accommodates the image forming medium P used for printing.

The manual feeding tray 102 is a table for manually feeding the image forming medium P.

The sheet feeding roller 103 is rotated by an operation of a motor to convey the image forming medium P accommodated in the sheet feeding tray 101 or the manual feeding tray 102 out from the sheet feeding tray 101. The toner cartridge 104 stores toner to be supplied to the image forming unit 105. The image forming device 100 includes a plurality of toner cartridges 104. As illustrated in FIG. 2, for example, the image forming device 100 includes four toner cartridges 104 including a toner cartridge 1041, a toner cartridge 1042, a toner cartridge 1043, and a toner cartridge 1044. The toner cartridge 1041, the toner cartridge 1042, the toner cartridge 1043, and the toner cartridge 1044 store toner corresponding to colors of cyan, magenta, yellow, and key (black) (CMYK). Colors of the toner stored in the toner cartridge 104 are not limited to the colors of CMYK, and may be other colors. The toner stored in the toner cartridge 104 may be special toner. For example, the toner cartridge 104 may store decolorable toner that is decolored to be invisible at a temperature higher than a predetermined temperature.

The image forming unit 105 includes a developing device, a photosensitive drum, and the like. The developing device develops an electrostatic latent image on a surface of a photosensitive drum using toner supplied from the toner cartridge 104. Accordingly, a toner image is formed on the surface of the photosensitive drum. The image formed on the surface of the photosensitive drum is transferred (primary transfer) onto the transfer belt 107. The image forming device 100 includes a plurality of image forming units 105. As illustrated in FIG. 2, for example, the image forming device 100 includes four image forming units 105 including an image forming unit 1051, an image forming unit 1052, an image forming unit 1053, and an image forming unit 1054. The image forming unit 1051, the image forming unit 1052, the image forming unit 1053, and the image forming unit 1054 form images by receiving supplies of toner corresponding to respective colors of CMYK.

The optical scanning device 106 is also called a laser scanning unit (LSU) or the like. The optical scanning device 106 forms an electrostatic latent image on a surface of a photosensitive drum of each of the image forming units 105 using laser light controlled according to image data.

The transfer belt 107 is, for example, an endless belt, and can be rotated by an operation of a roller. The transfer belt 107 is rotated to convey an image transferred from each of the image forming units to a position of the transfer rollers 108.

The transfer rollers 108 include two rollers facing each other. The transfer rollers 108 transfer (secondary transfer) an image formed on the transfer belt 107 onto the image forming medium P passing between the transfer rollers 108.

The fixing unit 109 heats and pressurizes the image forming medium P to which the image is transferred. Accordingly, the image transferred onto the image forming medium P is fixed. The fixing unit 109 includes the heating unit 110 and the pressure roller 111 that face each other.

The heating unit 110 is, for example, a roller including a heat source for heating the heating unit 110. The heat source is, for example, a heater. The roller heated by the heat source heats the image forming medium P.

Alternatively, the heating unit 110 may include an endless belt suspended by a plurality of rollers. For example, the heating unit 110 includes a plate-shaped heat source, an endless belt, a belt conveyance roller, a tension roller, and a press roller. The endless belt is, for example, a film-shaped member. The belt conveyance roller drives the endless belt. The tension roller applies tension to the endless belt. A surface of the press roller is formed with an elastic layer. The plate-shaped heat source forms a fixing nip having a predetermined width between the plate-shaped heat source and the press roller by bringing a heating portion into contact with an inner side of the endless belt and pressing the heating portion in a direction of the press roller. Since the plate-shaped heat source performs heating while forming a nip region, responsiveness at the time of energization is higher than responsiveness in a case using a heating method of a halogen lamp.

For the endless belt, for example, a silicon rubber layer having a thickness of 200 μm is formed on an outer side of a stainless use steel (SUS) base material having a thickness of 50 μm or on polyimide that is heat resistant resin having a thickness of 70 μm, and an outermost periphery is coated with a surface protective layer such as perfluoroalkoxy alkane (PFA). For the press roller, for example, a silicon sponge layer having a thickness of 5 mm is formed on a surface of an iron rod having a diameter ¢ of 10 mm, and an outermost periphery is coated with a surface protective layer such as PFA.

In the plate-shaped heat source, for example, a glaze layer and a heat resistance layer are stacked on a ceramic substrate. An aluminum heat sink is bonded to the plate-shaped heat source in order to release excess heat to an opposite side and prevent warpage of the substrate. The heat resistance layer is formed of a known material such as TaSiO₂, and is divided to have a predetermined length and a predetermined number in a main scanning direction.

The pressure roller 111 pressurizes the image forming medium P passing between the pressure roller 111 and the heating unit 110.

The sheet discharge tray 112 is a table to which the image forming medium P on which printing is completed is discharged.

The duplex unit 113 enables printing on a back surface of the image forming medium P. For example, the duplex unit 113 reverses the image forming medium P by switching back the image forming medium P using a roller or the like.

The scanning unit 114 reads an image from a document. The scanning unit 114 corresponds to a scanner for reading an image from a document.

The scanner is, for example, an optical reduction system including an imaging element such as a charge-coupled device (CCD) image sensor. Alternatively, the scanner is a contact image sensor (CIS) system including an imaging element such as a complementary metal-oxide-semiconductor (CMOS) image sensor. Alternatively, the scanner is of another known type.

The document feeding device 115 is also called, for example, an auto document feeder (ADF). The document feeding device 115 sequentially conveys documents placed on a document tray. Images of the conveyed documents are read by the scanning unit 114. The document feeding device 115 may include a scanner for reading an image from a back surface of a document.

The control panel 116 functions as a user interface, and includes a button and a touch panel for an operator of the image forming device 100 to operate the control panel 116. The touch panel is, for example, a stacked body of a display such as a liquid crystal display or an organic EL display and a pointing device based on a touch input. Therefore, the button and the touch panel function as an input device that receives an operation performed by an operator of the image forming device 100. The display included in the touch panel functions as a display device that notifies an operator of the image forming device 100 of various kinds of information.

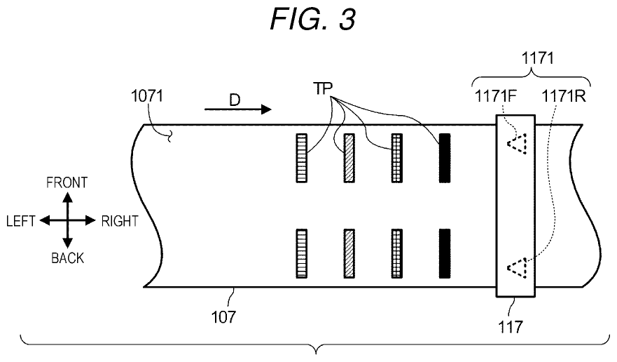

FIG. 3 is a schematic configuration diagram illustrating an example of the sensor unit 117. In FIG. 3, a front direction of the paper is a downward direction of the image forming device 100, and a depth direction of the paper is an upward direction of the image forming device 100. Front, back, left, and right directions of the image forming device 100 are as illustrated in FIG. 3.

The sensor unit 117 may include N binarization sensors 1171, N being an integer of 2 or more. For example, as illustrated in FIG. 3, the sensor unit 117 includes a front binarization sensor 1171F and a rear binarization sensor 1171R as two binarization sensors 1171, and in this case, N =2.

The sensor unit 117 is attached to a lower side of the transfer belt 107 in a manner in which detection ranges of the binarization sensors 1171 are toner image forming surfaces of the transfer belt 107. An attachment position of the sensor unit 117 is a latter stage position of the image forming unit 105 in a moving direction D of the transfer belt 107, that is, between the image forming unit 105 and the transfer rollers 108. If the sensor unit 117 is attached at such an attachment position, the binarization sensors 1171 can detect a toner image (hereinafter, referred to as a test pattern image TP) corresponding to a test pattern formed on the transfer belt 107. Details of the test pattern image TP will be described later.

For example, the binarization sensor 1171 may include an optical sensor and an analogue to digital converter (ADC). The optical sensor includes a light emitting unit and a light receiving unit, and detects a difference in surface properties between a toner image and the transfer belt 107. Specifically, the light emitting unit emits light toward the transfer belt 107. A light amount can be adjusted by a voltage value of a voltage input to the light emitting unit. The light receiving unit receives light reflected from a surface of the transfer belt 107 (hereinafter referred to as a belt surface 1071) or a toner image formed on the belt surface 1071, and outputs a reflected light amount voltage value corresponding to an amount of the received light as a sensor detection value. The ADC obtains a sensor output value by binarizing the sensor detection value.

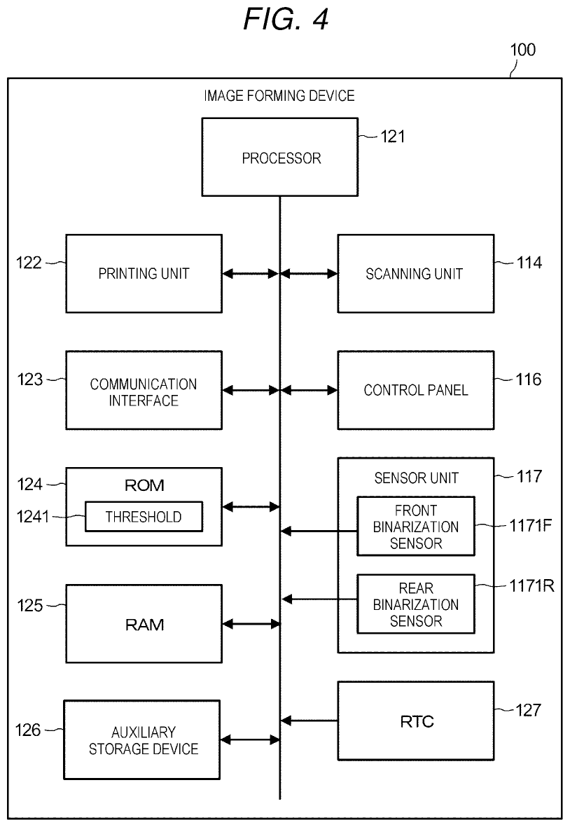

FIG. 4 is a block diagram illustrating an example of a circuit configuration of the image forming device 100 according to the first embodiment. The image forming device 100 includes, for example, a processor 121, a printing unit 122, a communication interface 123, a read-only memory (ROM) 124, a random-access memory (RAM) 125, an auxiliary storage device 126, the scanning unit 114, the control panel 116, the sensor unit 117, and a real-time clock (RTC) 127.

The processor 121 corresponds to a central part of a computer that executes processing such as calculation and control necessary for an operation of the image forming device 100. The processor 121 controls units for implementing various functions of the image forming device 100 based on a program such as system software, application software, or firmware stored in the ROM 124 or the auxiliary storage device 126. The processor 121 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 121 is a combination of a plurality of these units.

The ROM 124 is a non-transitory computer-readable storage medium, and corresponds to a main storage device of a computer including the processor 121 as a central part. The ROM 124 is a nonvolatile memory uniquely used for reading data. The ROM 124 stores data or various setting values used by the processor 121 to perform various kinds of processing. For example, the ROM 124 stores a threshold 1241. The threshold 1241 is a value used as a criterion for determining whether there is an abnormality in abnormality detection processing to be described later.

The RAM 125 corresponds to a main storage device of a computer including the processor 121 as a central part. The RAM 125 is a memory used for reading and writing data. The RAM 125 is used as a so-called work area or the like for temporarily storing data when the processor 121 executes various kinds of processing.

The auxiliary storage device 126 is a non-transitory computer-readable storage medium, and corresponds to an auxiliary storage device of a computer including the processor 121 as a central part. The auxiliary storage device 126 is, for example, an electric erasable programmable read-only memory (EEPROM) (registered trademark), a hard disk drive (HDD), and a solid state drive (SSD). The auxiliary storage device 126 stores data used by the processor 121 to execute various kinds of processing, data generated by processing in the processor 121, various kinds of setting values, or the like.

The image forming device 100 may include an interface into which a storage medium such as a removable optical disk, a memory card, or a universal serial bus (USB) memory can be inserted, instead of the auxiliary storage device 126 or in addition to the auxiliary storage device 126.

The program stored in the ROM 124 or the auxiliary storage device 126 includes a program for executing processing to be described later. For example, the image forming device 100 is handed over to an administrator or the like of the image forming device 100 in a state where the program is stored in the ROM 124 or the auxiliary storage device 126. Alternatively, the image forming device 100 may be handed over to the administrator or the like in a state where the program is not stored in the ROM 124 or the auxiliary storage device 126. The program for executing the processing to be described later may be separately transferred to the administrator or the like, and may be written in the ROM 124 or the auxiliary storage device 126 by an operation of the administrator, a serviceman, or the like. The transfer of the program at this time can be implemented by recording the program in a removable storage medium such as a magnetic disk, a magneto-optical disk, an optical disk, or a semi-conductor memory, or by downloading the program via a network or the like.

The program that is stored in the ROM 124 or the auxiliary storage device 126 and is used for executing the processing to be described later may include the threshold 1241 described above. In other words, the threshold 1241 may be stored in the auxiliary storage device 126 instead of being stored in the ROM 124 as illustrated in FIG. 4.

The communication interface 123 includes an interface through which the image forming device 100 communicates with the server 200 or the like via the network NW or the like. The communication interface 123 includes an interface that communicates with a user terminal such as a personal computer in a wired or wireless manner.

The RTC 127 is a clock or a circuit having a clock function.

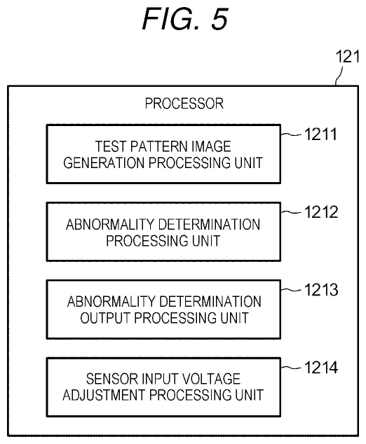

A configuration example of the processor 121 of the image forming device 100 will be described with reference to FIG. 5. FIG. 5 is a block diagram illustrating a configuration example of the processor 121 of the image forming device 100 according to the first embodiment.

The processor 121 includes a test pattern image generation processing unit 1211, an abnormality determination processing unit 1212, an abnormality determination output processing unit 1213, and a sensor input voltage adjustment processing unit 1214. The processor 121 implements functions of the test pattern image generation processing unit 1211, the abnormality determination processing unit 1212, the abnormality determination output processing unit 1213, and the sensor input voltage adjustment processing unit 1214 by executing programs stored in the ROM 124 or the auxiliary storage device 126. The test pattern image generation processing unit 1211, the abnormality determination processing unit 1212, the abnormality determination output processing unit 1213, and the sensor input voltage adjustment processing unit 1214 may be implemented by hardware such as a large scale integration (LSI), an application specific integrated circuit (ASIC), and a field-programmable gate array (FPGA) having the same functions as those implemented by executing programs by the processor 121.

The test pattern image generation processing unit 1211 executes processing of generating a test pattern image TP on the transfer belt 107 when power is turned on.

The abnormality determination processing unit 1212 executes processing of determining whether an abnormality including optical sensor contamination or belt abrasion occurred based on a detection result of the test pattern image TP detected by the front binarization sensor 1171F and the rear binarization sensor 1171R of the sensor unit 117.

If an abnormality occurs, the abnormality determination output processing unit 1213 executes processing of outputting information indicating that an abnormality occurs. Details of an output method will be described later.

The sensor input voltage adjustment processing unit 1214 executes processing of adjusting an input voltage of the front binarization sensor 1171F and/or the rear binarization sensor 1171R according to an abnormality occurrence output.

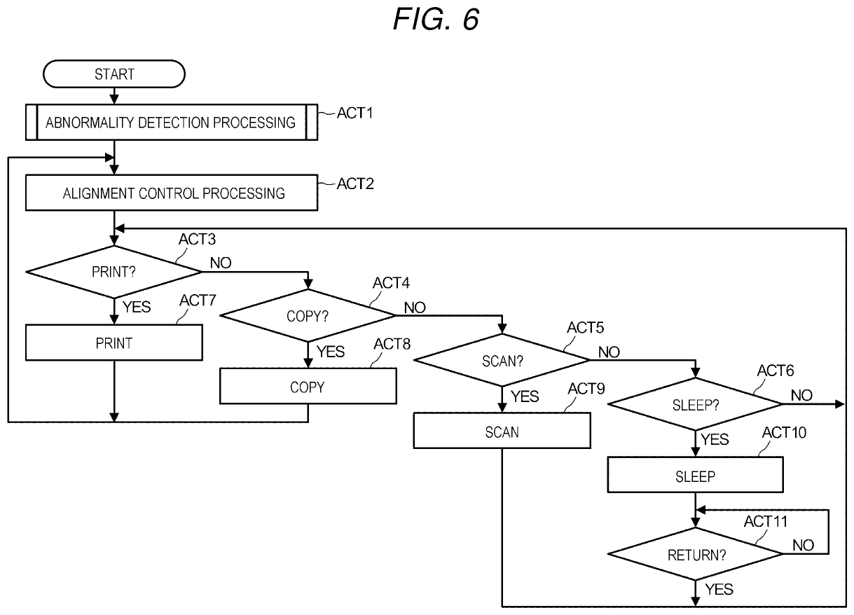

Hereinafter, an operation of the image forming device 100 according to the first embodiment will be described with reference to FIGS. 6 to 10. Processing contents to be described below are merely examples, and various kinds of processing capable of obtaining the same effect can be appropriately used.

FIG. 6 is a flowchart illustrating an example of an overall operation of the image forming device according to the first embodiment. The processor 121 executes processing based on a program stored in the ROM 124 or the auxiliary storage device 126. Unless otherwise specified, the processing of the processor 121 transitions to ACT (x+1) after ACT x (x is a natural number).

The image forming device 100 starts the processing illustrated in FIG. 6 when a power switch provided in the control panel 116 or in a casing of the image forming device 100 is operated to turn on the power.

In ACT 1, the processor 121 executes abnormality detection processing. Details of the abnormality detection processing will be described later.

In ACT 2, the processor 121 executes alignment control processing. In the alignment control processing, the processor 121 causes the plurality of image forming units 105 to form test pattern images TP, and calculates image formation timing adjustment values when the image forming units 105 form images.

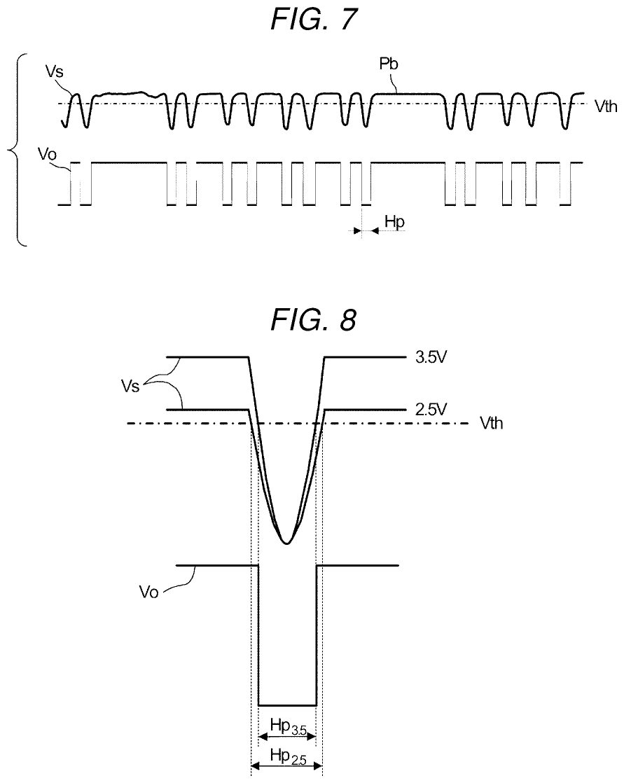

FIG. 7 is a diagram illustrating an example of waveforms of sensor detection values Vs and sensor output values Vo of the binarization sensors 1171. As described above, the binarization sensors 1171 that can detect a toner image on the transfer belt 107 include an optical sensor that detects a difference in surface properties between the toner image and the transfer belt 107. It is known that the belt surface 1071 having a high surface property exhibits a high sensor detection value Vs, and the toner image having a low surface property exhibits a low sensor detection value Vs in the optical sensor. For example, in the waveform of the sensor detection value Vs illustrated in FIG. 7, a portion Pb where the sensor detection value Vs has a high value corresponds to the belt surface 1071, and a valley portion corresponds to a portion where the toner image is present.

The binarization sensors 1171 binarize sensor detection values Vs by setting a binarization threshold Vth of the ADC to a value between a toner image detection value and a belt surface detection value. When the belt surface 1071 and the toner image are read, since values of the sensor detection value Vs change, in an output of the ADC illustrated as the sensor output value Vo in FIG. 7, a portion where the toner image is present and a portion where the toner image is absent are turned on or off (1 or 0), and the sensor detection value Vs can be binarized.

By binarizing the sensor detection value Vs in such a manner, for example, in a case where a toner image of a solid pattern is formed on the belt surface 1071, the sensor output value Vo is turned on for the belt surface 1071, and when the solid pattern is read, the sensor output value Vo is turned off. When the solid pattern passes, the sensor output value Vo is turned on again for the belt surface 1071. Thus, ON→OFF→ON can be detected. Based on a time from ON to ON and a moving speed of the belt surface 1071, a detection timing of the toner image detected by the optical sensor and a width of the toner image, that is, a pattern line width Hp of the solid pattern can be detected.

In the alignment control processing in ACT 2, the processor 121 can determine a positional misalignment of the toner image, that is, a writing positional misalignment when a latent image is formed on a photosensitive drum of each of the image forming units 105, by using the results, that is, based on the detection timing of the toner image and the pattern line width Hp. The processor 121 determines a timing of forming the latent image on the photosensitive drum so that an image is transferred to an appropriate position of the transfer belt 107 based on the determined writing positional misalignment.

Specifically, in the alignment control processing in ACT 2, the processor 121 can execute two types of alignment control, that is, alignment control of each of the image forming units 105 and alignment control among the plurality of image forming units 105.

In the alignment control of each of the image forming units 105, the processor 121 causes one image forming unit 105 that is an alignment control target to form a test pattern image TP on the belt surface 1071 of the transfer belt 107. The test pattern image TP is a solid pattern that can be detected at the same timing by the front binarization sensor 1171F and the rear binarization sensor 1171R that are arranged in a direction orthogonal to the moving direction D of the transfer belt 107. In the present embodiment, as illustrated in FIG. 3, the test pattern image TP includes two solid rectangular patterns extending in the direction orthogonal to the moving direction D of the transfer belt 107 and having the same pattern line width. For example, if the image forming unit 1054 is an alignment control target, only a solid rectangular pattern of a black solid illustrated in FIG. 3 is formed as the test pattern image TP on the belt surface 1071. The test pattern image TP may be formed as one continuous solid rectangular pattern. Based on a distance from the image forming unit 105 to the sensor unit 117 and the moving speed of the transfer belt 107, the processor 121 can calculate at what timing and for how long the front binarization sensor 1171F and the rear binarization sensor 1171R detect the test pattern image TP from a time point when the image forming unit 105 forms the test pattern image TP. The processor 121 recognizes a timing misalignment between the start and the end of the formation of the toner image performed by the image forming unit 105, that is, a positional misalignment of a formed image, by comparing a calculated expected value with actual sensor output values Vo of the front binarization sensor 1171F and the rear binarization sensor 1171R. Based on the positional misalignment of the image, the processor 121 calculates an image formation timing adjustment value when the image forming unit 105 forms an image thereafter.

In a color misalignment adjustment which is the alignment control among the plurality of image forming units 105, the processor 121 causes the plurality of image forming units 105, that is, the image forming units 1051 to 1054, to simultaneously form the test pattern images TP having the same line width on the belt surface 1071 of the transfer belt 107. In this case, as illustrated in FIG. 3, the test pattern images TP are formed as solid rectangular patterns of four colors. Based on a distance between the image forming units 105 and the moving speed of the transfer belt 107, the processor 121 can calculate at what timing a test pattern image TP formed by the subsequent image forming unit 105 is to be detected from a time point when the front binarization sensor 1171F and the rear binarization sensor 1171R detect a test pattern image TP formed by one image forming unit 105. The processor 121 recognizes a timing misalignment of the formation of toner images among the plurality of image forming units 1051 to 1054, that is, a color misalignment of formed images, by comparing a calculated expected value with actual sensor output values Vo of the front binarization sensor 1171F and the rear binarization sensor 1171R. Based on the color misalignment of the images, the processor 121 calculates an image formation timing adjustment value when the image forming units 105 form images thereafter.

If a subsequent image is formed, the processor 121 adjusts an image formation timing in the image forming units 105 according to the timing adjustment value calculated in this manner.

Although only one sensor unit 117 is provided in FIGS. 2, 3, and 4, a plurality of sensor units 117 may be arranged in a longitudinal direction of the transfer belt 107 that is the moving direction D of the transfer belt 107. With a configuration in such a case, the processor 121 can detect a plurality of test pattern images TP at a time by forming test pattern images TP by the image forming units 105 on the belt surface 1071 at an interval corresponding to an arrangement interval of the plurality of sensor units 117 in the alignment control. Accordingly, it is possible to simultaneously execute the two types of alignment control, that is, the alignment control of each of the image forming units 105 and the alignment control among the plurality of image forming units 105.

The description is back to the description of FIG. 6.

In ACT 3, the processor 121 determines whether to perform a printing operation. For example, the processor 121 can determine whether there is a printing job from a user terminal using the communication interface 123, thereby determining whether to perform a printing operation.

Based on a determination indicating that a printing operation is not to be performed (ACT 3, NO), the processor 121 determines whether to perform a copying operation in ACT 4. For example, the processor 121 can determine whether a copying operation is selected on the control panel 116, thereby determining whether to perform a copying operation.

Based on a determination indicating that a copying operation is not to be performed (ACT 4, NO), the processor 121 determines whether to perform a scanning operation in ACT 5. For example, the processor 121 can determine whether a scanning operation is selected on the control panel 116, thereby determining whether to perform a scanning operation.

Based on a determination indicating that a scanning operation is not to be executed (ACT 5, NO), the processor 121 determines whether to transition to a sleep state in ACT 6. For example, the processor 121 can determine whether a state in which a printing operation, a copying operation, or a scanning operation is not performed is continued for a certain period of time, thereby determining whether to transition to a sleep state.

The processor 121 transitions to a processing operation in ACT 3 based on a determination indicating not to transition to a sleep state (ACT 6, NO).

In this manner, the processor 121 repeats processing operations in ACT 3 to ACT 6.

Based on a determination indicating that a printing operation is to be performed (ACT 3, YES), the processor 121 causes the printing unit 122 to perform the printing operation according to a printing job in ACT 7. At this time, the processor 121 adjusts image formation timings in the image forming units 105 of the printing unit 122 according to the timing adjustment value calculated in ACT 2. After the printing operation is completed, the processor 121 proceeds to a processing operation in ACT 2. As described above, the alignment control processing is executed for each printing operation in the present embodiment. It should be noted that the printing operation is not performed in units of individual printing of a plurality of pieces of printing included in one printing job, but is performed in units of all pieces of printing included in one printing job. If a plurality of printing jobs are given from one user terminal, the plurality of printing jobs may be used as a unit.

Based on a determination indicating that a copying operation is to be performed (ACT 4, YES), the processor 121 causes the scanning unit 114 and the printing unit 122 to perform the copying operation in ACT 8. That is, an image of a document is read by the scanning unit 114, and the read image is printed by the printing unit 122. If the printing is performed, the processor 121 adjusts image formation timings in the image forming units 105 of the printing unit 122 according to the timing adjustment value calculated in ACT 2. After the copying operation is completed, the processor 121 proceeds to the processing operation in ACT 2. As described above, the alignment control processing is executed for each copying operation in the present embodiment. It should be noted that the copying operation is not performed in units of individual copying of a plurality of documents sequentially conveyed to the scanning unit 114 by the document feeding device 115, but in units of all pieces of copying of the plurality of documents.

Based on a determination indicating that a scanning operation is to be performed (ACT 5, YES), the processor 121 causes the scanning unit 114 to perform the scanning operation in ACT 9. After the scanning operation is completed, the processor 121 proceeds to the processing operation in ACT 3. That is, since printing is not performed in the scanning operation, there is no change in contamination of the front binarization sensor 1171F and the rear binarization sensor 1171R and a surface property of the belt surface 1071 of the transfer belt 107. Therefore, the alignment control processing in ACT 2 may not be executed.

Based on a determination indicating to transition to a sleep state (ACT 6, YES), the processor 121 transitions to a sleep state in ACT 10. In the sleep state, power is supplied only to a minimum necessary portion, and power supply to other portions is stopped to reduce power consumption.

In ACT 11, the processor 121 determines whether to return to a normal state. For example, the processor 121 determine whether the communication interface 123 can receives a signal, whether the control panel 116 is touched, whether a document is set in the document feeding device 115, whether person approach is detected by a sensor such as a human sensor if the sensor is provided, and the like, thereby determining whether to return to a normal state. If it is determined to not return to the normal state (ACT 11, NO), the processor 121 continues this determination. If it is determined to return to the normal state (ACT 11, YES), the processor 121 proceeds to the processing operation in ACT 3. In this case, since printing is not performed, the alignment control processing in ACT 2 may not be executed.

Next, the abnormality detection processing executed in ACT 1 will be described.

In the image forming device 100, the binarization sensors 1171 are contaminated or the surface property of the belt surface 1071 of the transfer belt 107 is deteriorated due to factors such as life of a consumable item and a use environment such as toner scattering. If such a failure occurs, the sensor output values Vo of the binarization sensors 1171 vary.

In particular, the occurrence of the failure lowers the sensor detection value Vs at the time of detecting the belt surface 1071. FIG. 8 is a diagram illustrating a relationship between magnitudes of sensor detection values Vs and pattern line widths Hp appearing as sensor output values Vo. In a case where the sensor detection value Vs at the time of detecting the belt surface 1071 is lowered, even if a width of a toner image is constant, the width of the toner image appears to change in the sensor output value Vo at the time of binarizing due to an influence in a decrease in voltage at the time of switching from reading the belt surface 1071 to reading the toner image and a rise in voltage at the time of switching from reading the toner image to reading the belt surface 1071. That is, as illustrated in FIG. 8, timings when the sensor detection values Vs reach a binarization threshold Vth are misaligned due to magnitudes of the sensor detection values Vs at the time of detecting the belt surface 1071, and pattern line widths Hp appearing in the sensor output valuez Vo change. For example, a pattern line width Hp_{2.5} appearing in the sensor output value Vo if the sensor detection value Vs at the time of detecting the belt surface 1071 is 2.5 V is larger than a pattern line width Hp_{3.5} appearing in the sensor output value Vo if the sensor detection value Vs at the time of detecting the belt surface 1071 is 3.5 V.

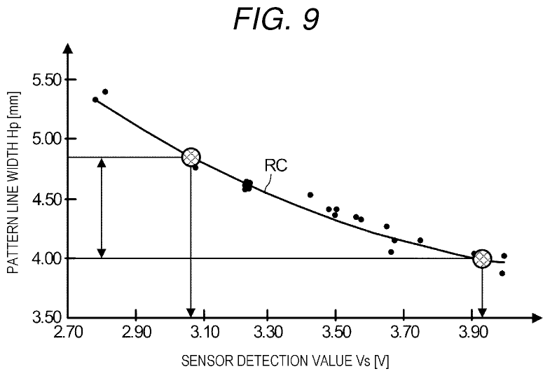

FIG. 9 is a diagram illustrating an example of a relationship between pattern line widths Hp and sensor detection values Vs. The sensor detection value Vs here is a detection value of the belt surface 1071 of the binarization sensor 1171 if a pattern line width is constant at, for example, 4 mm. The pattern line width Hp indicates a pattern line width appearing in the sensor output value Vo. As illustrated in FIG. 9, it is known that there is a correlation such as a relationship curve RC between the sensor detection value Vs at the time of detecting the belt surface 1071 and the pattern line width Hp at the time of binarizing.

In the present embodiment, a toner image having a constant width is formed on the belt surface 1071 in correspondence with reading positions of a plurality of binarization sensors 1171, and the pattern line widths Hp calculated from ON and OFF detection timings detected by the plurality of binarization sensors 1171 are compared with one another to determine whether there is an abnormality in the sensor detection values Vs, that is, whether there is optical sensor contamination or belt abrasion. For example, as illustrated in FIG. 3, if the front binarization sensor 1171F is disposed on a front side of the image forming device 100 and the rear binarization sensor 1171R is disposed on a rear side of the image forming device 100, toner images corresponding to test pattern images TP having a width of 4 mm are formed on both the front side and the rear side, and the toner images are read by the front binarization sensor 1171F and the rear binarization sensor 1171R. Pattern line widths Hp are estimated from ON and OFF timings. For example, as illustrated in FIG. 9, if the pattern line width Hp is calculated to be 4.0 mm in the front binarization sensor 1171F and the pattern line width Hp is calculated to be 4.8 mm in the rear binarization sensor 1171R, the processor 121 calculates 0.8 mm as a difference between the pattern line widths Hp. Since the difference of 0.8 mm is larger than, for example, 0.5 mm that is the threshold 1241 stored in the ROM 124, the processor 121 can determine that there is an abnormality.

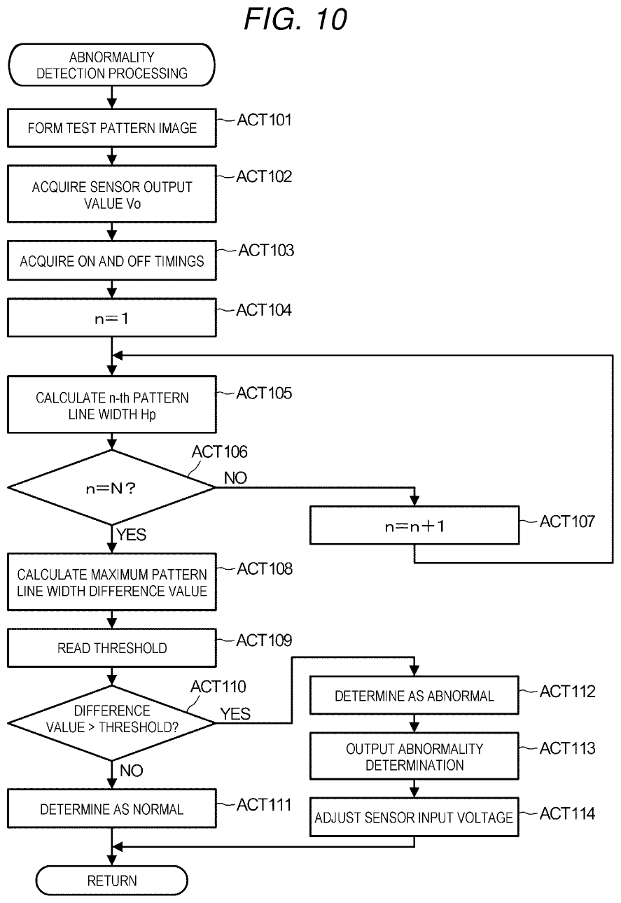

FIG. 10 is a flowchart illustrating an example of the abnormality detection processing operation performed by the image forming device 100 according to the first embodiment. That is, FIG. 10 is a flowchart illustrating details of the abnormality detection processing in ACT 1 illustrated in FIG. 6.

In ACT 101, the processor 121 (the test pattern image generation processing unit 1211) causes one of the image forming units 105, for example, the image forming unit 1054, to form a test pattern image TP on the belt surface 1071 of the transfer belt 107.

In ACT 102, the processor 121 (the abnormality determination processing unit 1212) acquires the sensor output values Vo of the N binarization sensors 1171 corresponding to periods before, including, and after the test pattern image TP. In the example illustrated in FIGS. 3 and 4, the processor 121 (the abnormality determination processing unit 1212) acquires two sensor output values Vo of the front binarization sensor 1171F and the rear binarization sensor 1171R. The processor 121 stores the acquired N sensor output values Vo in the RAM 125. In ACT 103, the processor 121 (the abnormality

determination processing unit 1212) acquires ON and OFF timings of the binarization sensors 1171 based on the N sensor output values Vo stored in the RAM 125. The processor 121 stores the acquired N ON and OFF timings in the RAM 125.

In ACT 104, the processor 121 (the abnormality determination processing unit 1212) initializes a value of a counter n included in the processor 121 or provided in the RAM 125 to “1”.

In ACT 105, the processor 121 (the abnormality determination processing unit 1212) calculates the pattern line width Hp of the test pattern image TP based on an n-th ON and OFF timing indicated by a value of the counter n among the N ON and OFF timings stored in the RAM 125. The processor 121 stores the calculated n-th pattern line width Hp in the RAM 125.

In ACT 106, the processor 121 (the abnormality

determination processing unit 1212) determines whether the value of the counter n is N that is the number of the binarization sensors 1171.

Based on a determination result indicating that the value of the counter n is not N (ACT 106, NO), the processor 121 (the abnormality determination processing unit 1212) increments the value of the counter n by “+1” in ACT 107. Thereafter, the processor 121 proceeds to a processing operation in ACT 105.

In this manner, the processor 121 (the abnormality determination processing unit 1212) repeats processing operations in ACT 105 to ACT 107 and calculates N pattern line widths Hp.

Based on a determination result indicating that the value of the counter n is N (ACT 106, YES), the processor 121 (the abnormality determination processing unit 1212) calculates a maximum pattern line width difference value based on the N pattern line widths Hp stored in the RAM 125. Specifically, the processor 121 determines a maximum pattern line width Hp and a minimum pattern line width Hp among the N pattern line widths Hp, and calculates a difference value between the maximum pattern line width Hp and the minimum pattern line width Hp. The processor 121 stores the calculated maximum pattern line width difference value in the RAM 125.

In ACT 109, the processor 121 (the abnormality determination processing unit 1212) reads a threshold stored in the ROM 124 as the threshold 1241.

In ACT 110, the processor 121 (the abnormality determination processing unit 1212) compares the read threshold with the maximum pattern line width difference value stored in the RAM 125, and determines whether the maximum pattern line width difference value exceeds the threshold.

Based on a determination result indicating that the maximum pattern line width difference value does not exceed the threshold (ACT 110, NO), the processor 121 (the abnormality determination processing unit 1212) determines that the sensor detection value Vs is normal in ACT 111. Then, the processor 121 returns to an upper routine and proceeds to the processing operation in ACT 2.

Based on a determination result indicating that the maximum pattern line width difference value exceeds the threshold (ACT 110, YES), the processor 121 (the abnormality determination processing unit 1212) determines that the sensor detection value Vs is abnormal, that is, there is an abnormality such as optical sensor contamination or belt abrasion in ACT 112. For example, as described above with reference to FIG. 9, if the pattern line width Hp is calculated as 4.0 mm in the front binarization sensor 1171F and the pattern line width Hp is calculated as 4.8 mm in the rear binarization sensor 1171R, the maximum pattern line width difference is calculated as 0.8 mm. If 0.5 mm is stored as the threshold 1241, since 0.8>0.5, it is determined that the maximum pattern line width difference value exceeds the threshold, and it is determined that there is an abnormality.

If it is determined that there is an abnormality, it is considered that the sensor detection values Vs corresponding to the belt surface 1071 are misaligned due to contamination of one of the N binarization sensors 1171, for example, contamination of the front binarization sensor 1171F or the rear binarization sensor 1171R or contamination or damage of the belt surface 1071 of the transfer belt 107. Therefore, in ACT 2, if the alignment control is performed by using the pattern line widths Hp based on the sensor output values Vo according to the sensor detection values Vs that are misaligned, it is assumed that a failure of a positional misalignment or the like occurs.

In ACT 113, the processor 121 (the abnormality determination output processing unit 1213) outputs an abnormality determination. For example, the processor 121 displays information indicating that there is an abnormality on the control panel 116. Alternatively, the processor 121 causes the communication interface 123 to transmit information indicating occurrence of an abnormality and, for example, a specific value of the pattern line width Hp to the server 200 via the network NW. Accordingly, it is possible to request a serviceman to take measures such as checking a state, cleaning or replacing the binarization sensor 1171 that leads to the abnormality determination, and cleaning or replacing the transfer belt 107 that leads to the abnormality determination.

In ACT 114, the processor 121 (the sensor input voltage adjustment processing unit 1214) adjusts a voltage input to the binarization sensor 1171. By adjusting the voltage input to the binarization sensor 1171, a changed value of the sensor detection value Vs corresponding to the belt surface 1071 is adjusted to be an appropriate value, and the pattern line width Hp is adjusted to be an original value, so that the alignment control can be performed appropriately. Then, the processor 121 returns to an upper routine and proceeds to the processing operation in ACT 2.

The following method can be considered as a method of adjusting the voltage input to the binarization sensor 1171.

First, an appropriate input voltage value estimated from the calculated maximum pattern line width difference value is calculated, and a value of a voltage input to the light emitting unit of the optical sensor included in the binarization sensor 1171 indicating the maximum pattern line width Hp is set to be the appropriate input voltage value.

Second, only the value of the voltage input to the light emitting unit of the optical sensor included in the binarization sensor 1171 indicating the maximum pattern line width Hp is changed by a constant input voltage value.

Third, the sensor output value Vo is checked and adjusted while adjusting the value of the voltage input to the light emitting unit of the optical sensor included in the binarization sensor 1171 indicating the maximum pattern line width Hp.

Fourth, any one of the first to third methods is applied not only to the binarization sensor 1171 indicating the maximum pattern line width Hp but also to other binarization sensors 1171.

As described above, the image forming device 100 according to the first embodiment includes the transfer belt 107 on which toner images are configured to be formed, a plurality of image forming units 105 arranged in the moving direction D of the transfer belt 107 and configured to form the toner images on the transfer belt 107, a plurality of binarization sensors 1171 configured to detect the toner images formed on the transfer belt 107, and the processor 121 configured to determine a relative positional misalignment among the toner images formed by the plurality of image forming units 105 based on detection results output from the plurality of binarization sensors 1171 and perform alignment control of adjusting formation timings of the toner images on the transfer belt 107 in the plurality of image forming units 105 based on a determination result. The processor 121 further functions as the abnormality determination processing unit 1212 to execute the abnormality determination processing based on a difference value of the detection results output from the plurality of binarization sensors 1171, and functions as the abnormality determination output processing unit 1213 to output the determination result of the abnormality determination processing. Accordingly, the processor 121 can determine and output an abnormality indicating that the sensor output value Vo of the binarization sensors 1171 varies due to contamination of the binarization sensors 1171 or deterioration of the surface property of the belt surface 1071 of the transfer belt 107 that is caused by factors such as life of a consumable item and a use environment such as toner scattering.

### Second Embodiment

Some types of image forming devices 100 can switch an image forming speed in the image forming units 105 and a moving speed of the transfer belt 107 in several stages according to an image to be formed. The present embodiment is an example of such an image forming device 100.

A basic configuration of an intercommunication system and the image forming device 100 according to a second embodiment is similar to the configuration of the intercommunication system and the image forming device 100 according to the first embodiment illustrated in FIGS. 1, 2, and 3. A circuit configuration of the image forming device 100 according to the second embodiment is basically similar to that of the image forming device 100 according to the first embodiment illustrated in FIGS. 4 and 5, and a part of the circuit configuration is different. Only differences in the circuit configuration will be described below.

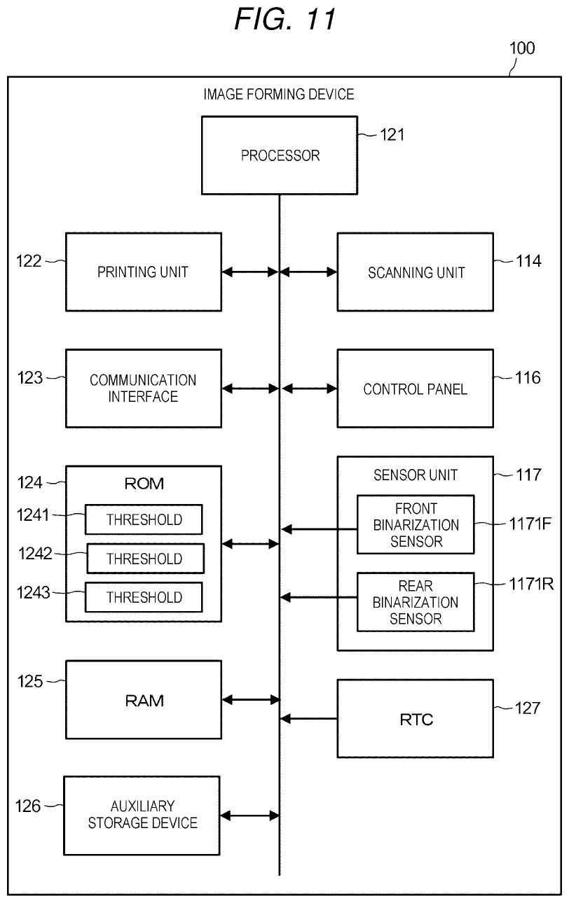

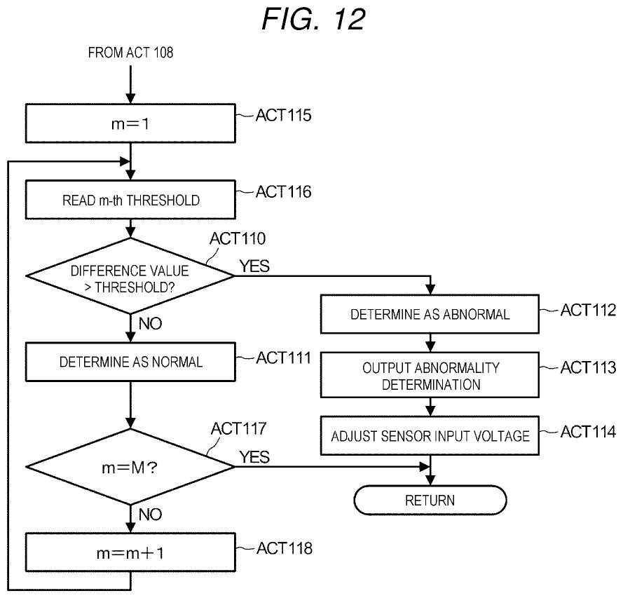

FIG. 11 is a block diagram illustrating an example of a circuit configuration of the image forming device 100 according to the second embodiment. In the present embodiment, the ROM 124 stores M thresholds corresponding to the number of speed switching stages, M being an integer of 2 or more. In the example illustrated in FIG. 11, thresholds 1241, 1242, and 1243 are stored in the ROM 124 as three speed corresponding thresholds, and in this case, M=3. The M thresholds are speed corresponding thresholds having values corresponding to an image forming speed and a belt moving speed.

An overall operation of the image forming device 100 according to the second embodiment is the same as the overall operation illustrated in FIG. 6 according to the first embodiment, and description thereof is omitted.

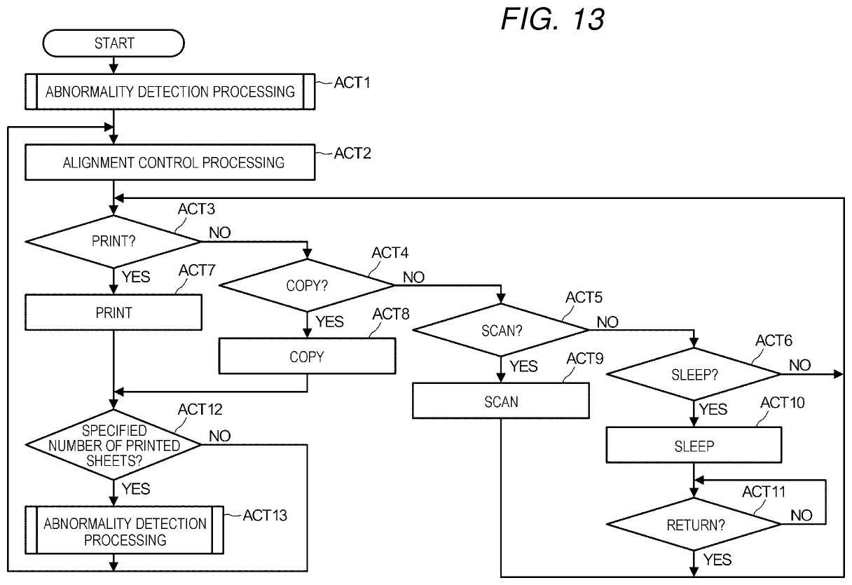

Hereinafter, an abnormality detection processing operation performed by the image forming device 100 according to the second embodiment will be described with reference to FIG. 12. Processing contents to be described below are merely examples, and various kinds of processing capable of obtaining the same result can be appropriately used.

FIG. 12 is a flowchart illustrating an example of the abnormality detection processing operation performed by the image forming device 100 according to the second embodiment. That is, FIG. 12 is a flowchart illustrating details of the abnormality detection processing in ACT 1 illustrated in FIG. 6. In FIG. 12, processing operations in ACTs 101 to 108 that are processing operations the same as those in the first embodiment are omitted.

Subsequent to ACT 108, in ACT 115, the processor 121 (the abnormality determination processing unit 1212) initializes a value of a counter m included in the processor 121 or provided in the RAM 125 to “1” in the present embodiment.

In ACT 116, the processor 121 (the abnormality determination processing unit 1212) reads an m-th threshold indicated by the value of the counter m among the M thresholds stored in the ROM 124.

Thereafter, as described in the first embodiment, in ACT 110, the processor 121 (the abnormality determination processing unit 1212) determines whether the maximum pattern line width difference value exceeds the threshold. Based on a determination result indicating that the maximum pattern line width difference value does not exceed the threshold (ACT 110, NO), in ACT 111, the processor 121 (the abnormality determination processing unit 1212) determines that the sensor detection value Vs is normal as described in the first embodiment.

In ACT 117, the processor 121 (the abnormality determination processing unit 1212) determines whether the value of the counter m is M that is the number of speed switching stages in the present embodiment.

Based on a determination result indicating that the value of the counter m is not M (ACT 117, NO), the processor 121 (the abnormality determination processing unit 1212) increments the value of the counter by “+1” in ACT 118. Thereafter, the processor 121 proceeds to the processing operation in ACT 116.

In this manner, the processor 121 (the abnormality determination processing unit 1212) repeats the processing operations in ACT 116, ACT 110, ACT 111, ACT 117, and ACT 118, and compares the M thresholds with the maximum pattern line width difference value.

Based on a determination result indicating that the value of the counter m is M (ACT 117, YES), the processor 121 (the abnormality determination processing unit 1212) returns to an upper routine and proceeds to the processing operation in ACT 2.

In ACT 110 during a period in which the processing operations in ACT 116, ACT 110, ACT 111, ACT 117, and ACT 118 are repeated, there may be a determination result indicating that the maximum pattern line width difference value exceeds one of the M thresholds. Based on the determination result indicating that the maximum pattern line width difference value exceeds the threshold (ACT 110, YES), the processor 121 (the abnormality determination processing unit 1212) performs the processing operations in ACT 112 to ACT 114 as described in the first embodiment, and thereafter, the processor 121 (the abnormality determination processing unit 1212) returns to an upper routine and transitions to the processing operation in ACT 2.

As described above in detail, the image forming device 100 according to the second embodiment includes the ROM 124 that is a memory storing a plurality of thresholds 1241 to 1243 respectively corresponding to a plurality of moving speeds set for the transfer belt 107 as thresholds of the abnormality determination, and the processor 121 tries the plurality of thresholds 1241 to 1243 one by one in the abnormality determination processing to generate a determination result indicating an abnormality. Accordingly, even in the image forming device 100 in which an image forming speed in the image forming unit 105 and a moving speed of the transfer belt 107 can be switched in several stages according to an image to be formed, the processor 121 can determine and output an abnormality indicating that the sensor output value Vo of the binarization sensors 1171 varies.

### Third Embodiment

In the first and second embodiments, the abnormality detection processing is executed only when power of the image forming device 100 is turned on. Alternatively, the abnormality detection processing may be executed at another timing. Hereinafter, an example of the image forming device 100 that performs the abnormality detection processing at another timing will be described as a third embodiment. Here, description of configurations and processing operations similar to those in the first and second embodiments will be omitted.

FIG. 13 is a flowchart illustrating an example of an overall operation of the image forming device 100 according to the third embodiment. In the present embodiment, after the printing operation in ACT 7 is performed or after the copying operation in ACT 8 is performed, the processor 121 determines whether the number of printed sheets reaches a specified number of printed sheets in ACT 12. The specified number of printed sheets may be, for example, every 500 sheets such as 500 sheets, 1000 sheets, 1500 sheets. The number of printed sheets of the image forming medium P can be stored in, for example, the auxiliary storage device 126 for each printing in the printing operation in ACT 7 and for each printing in the copying operation in ACT 8.

Based on a determination result indicating that the specified number of printed sheets is not reached (ACT 12, NO), the processor 121 proceeds to the processing operation in ACT 2.

Based on a determination result indicating that the specified number of printed sheets is reached (ACT 12, YES), the processor 121 executes the abnormality detection processing in ACT 13. The abnormality detection processing in ACT 13 is the same as the abnormality detection processing executed in ACT 1 in the first and second embodiments. After the abnormality detection processing is completed, the processor 121 proceeds to the processing operation in ACT 2.

The abnormality detection processing is not limited to the number of printed sheets, and an execution timing can be determined based on various conditions such as the number of times of power on and an operating time.

If the abnormality detection processing in ACT 13 according to a certain condition is performed, the abnormality detection processing each time power is turned on in ACT 1 may be omitted.

As described above, according to the image forming device 100 in the third embodiment, the processor 121 can determine and output an abnormality indicating that the sensor output value Vo of the binarization sensor 1171 varies even if the image forming device 100 is not turned on.

In the description of the first to third embodiments, the pattern line width Hp, the maximum pattern line width difference value, and the threshold use values in a distance unit of mm. In practice, since a time (timing) of an ON and OFF signal is acquired, a value of a time unit may be used for the pattern line width Hp, the maximum pattern line width difference value, and the threshold.

While certain embodiments have been described, these embodiments have been presented by way of example only, and are not intended to limit the scope of disclosure. Indeed, the novel apparatus and methods described herein may be embodied in a variety of other forms; furthermore, various

What is claimed is:

1. An image forming device, comprising:
a transfer belt on which toner images are formed;
a plurality of image forming components arranged in a moving direction of the transfer belt and configured to form the toner images on the transfer belt;
a plurality of sensors configured to detect the toner images formed on the transfer belt; and
a processor configured to
determine a relative positional misalignment among the toner images formed by the plurality of image forming components based on detection results output from the plurality of sensors,
perform alignment control of adjusting formation timings of the toner images on the transfer belt in the plurality of image forming components based on a determination result,
execute abnormality determination processing based on a difference value of the detection results output from the plurality of sensors, and
output a determination result of the abnormality determination processing.

2. The image forming device according to claim 1, wherein
the processor generates a determination result indicating an abnormality based on a difference value among the detection results output from the plurality of sensors exceeds a threshold value.

3. The image forming device according to claim 2, wherein
in the abnormality determination processing, the processor generates the determination result indicating the abnormality based on a maximum value of the difference value among the detection results output from the plurality of sensors exceeds the threshold value.

4. The image forming device according to claim 1, wherein
the plurality of image forming components form toner images of test patterns having the same width on the transfer belt in the moving direction of the transfer belt, and
in the abnormality determination processing, the processor is further configured to
calculate widths of the test patterns based on the detection results output from the plurality of sensors, and
generate a determination result indicating an abnormality based on a fact that a difference value among the widths of the test patterns exceeds a threshold value.

5. The image forming device according to claim 1, wherein
the plurality of sensors respectively comprise binarization sensors configured to output binary values of ON and OFF, and
in the abnormality determination processing, the processor generates a determination result indicating an abnormality based on a difference among ON and OFF timings of output values of the plurality of binarization sensors when toner images of test patterns having the same width are formed on the transfer belt in the moving direction of the transfer belt exceeds a threshold value.

6. The image forming device according to claim 5, wherein
the ON and OFF timings output from the binarization sensors comprise two switching timings of a switching timing from ON to OFF corresponding to a switching position from a surface of the transfer belt to the toner images of the test patterns and a switching timing from OFF to ON corresponding to a switching position from the toner images of the test patterns to the surface of the transfer belt, and
in the abnormality determination processing, the processor is further configured to
calculate reading widths of the toner images of the test patterns based on the two switching timings for the plurality of binarization sensors, and
generate the determination result indicating the abnormality based on a difference between the reading widths of the plurality of binarization sensors exceeds a threshold value.

7. The image forming device according to claim 1, wherein
when a determination result indicating an abnormality is output as the determination result, the processor changes an input voltage for at least one of the plurality of sensors.

8. The image forming device according to claim 1, further comprising:
a communication interface for communicating with an external device via a network, wherein
the processor causes the communication interface to output the determination result of the abnormality determination processing to the external device via the network.

9. The image forming device according to claim 2, further comprising:
a memory configured to store, as the threshold value, a plurality of threshold values respectively corresponding to a plurality of moving speeds set for the transfer belt, wherein
in the abnormality determination processing, the processor generates a determination result indicating an abnormality by trying the plurality of threshold values one by one.

10. The image forming device according to claim 1, wherein
the plurality of sensors are arranged in a direction orthogonal to the moving direction of the transfer belt.

11. An image forming method, comprising:
forming toner images on a transfer belt with a plurality of image forming components arranged in a moving direction of the transfer belt;
detecting the toner images formed on the transfer belt with a plurality of sensors;
determining a relative positional misalignment among the toner images formed by the plurality of image forming components based on detection results output from the plurality of sensors;
performing alignment control of adjusting formation timings of the toner images on the transfer belt in the plurality of image forming components based on a determination result;
executing abnormality determination processing based on a difference value of the detection results output from the plurality of sensors; and
outputting a determination result of the abnormality determination processing.

12. The image forming method according to claim 11, further comprising:
generating a determination result indicating an abnormality based on a difference value among the detection results output from the plurality of sensors exceeding a threshold value.

13. The image forming method according to claim 12, further comprising:
generating the determination result indicating the abnormality based on a maximum value of the difference value among the detection results output from the plurality of sensors exceed the threshold value.

14. The image forming method according to claim 11, further comprising:
forming toner images of test patterns having the same width on the transfer belt in the moving direction of the transfer belt;
calculating widths of the test patterns based on the detection results output from the plurality of sensors; and
generating a determination result indicating an abnormality based on a fact that a difference value among the widths of the test patterns exceeds a threshold value.

15. The image forming method according to claim 11, further comprising:
outputting binary values of ON and OFF with binarization sensors comprised within the plurality of sensors; and
generating a determination result indicating an abnormality based on a difference among ON and OFF timings of output values of the plurality of binarization sensors when toner images of test patterns having the same width are formed on the transfer belt in the moving direction of the transfer belt exceeds a threshold value.

16. The image forming method according to claim 11, further comprising:
changing an input voltage for at least one of the plurality of sensors when a determination result indicating an abnormality is output as the determination result.

17. The image forming method according to claim 11, further comprising:
communicating with an external device via a network; and
outputting the determination result of the abnormality determination processing to the external device via the network.

18. An image forming apparatus, comprising:
a sheet processing device; and
an image forming device, comprising:
a transfer belt on which toner images are formed;
a plurality of image forming components arranged in a moving direction of the transfer belt and configured to form the toner images on the transfer belt;
a plurality of sensors configured to detect the toner images formed on the transfer belt; and
a processor configured to
determine a relative positional misalignment among the toner images formed by the plurality of image forming components based on detection results output from the plurality of sensors,
perform alignment control of adjusting formation timings of the toner images on the transfer belt in the plurality of image forming components based on a determination result,
execute abnormality determination processing based on a difference value of the detection results output from the plurality of sensors, and
output a determination result of the abnormality determination processing.

19. The image forming device according to claim 18, wherein
the processor generates a determination result indicating an abnormality based on a difference value among the detection results output from the plurality of sensors exceeds a threshold value.

20. The image forming device according to claim 19, wherein
in the abnormality determination processing, the processor generates the determination result indicating the abnormality based on a maximum value of the difference value among the detection results output from the plurality of sensors exceeds the threshold value.
